(19) United States
(12) Patent Application Publication
(10) Pub. No.: US 2025/0334378 A1
(43) Pub. Date: Oct. 30, 2025

(54) UNIDIRECTIONAL ELECTROMAGNETIC WAVE STEALTH DEVICE AND METHOD FOR MANUFACTURING THE SAME

(71) Applicant: SUZHOU CITY UNIVERSITY, Suzhou (CN)

(72) Inventors: Fang Cao, Suzhou (CN); Lei Gao, Suzhou (CN); Jie Luo, Suzhou (CN); Dongyang Yan, Suzhou (CN); Cuiping Liu, Suzhou (CN)

(21) Appl. No.: 19/188,163

(22) Filed: Apr. 24, 2025

Related U.S. Application Data
(63) Continuation of application No. PCT/CN2024/089779, filed on Apr. 25, 2024.

(51) Int. Cl. F41H 3/00; G02B 1/00; G02B 5/02

(52) U.S. Cl. CPC F41H 3/00; G02B 1/005; G02B 5/0242; G02B 5/0268; G02B 5/0278; G02B 5/0294

(57) ABSTRACT

The invention provides a unidirectional electromagnetic wave stealth device and a manufacturing method thereof. The device includes a first photonic crystal doped with a lossy dopant, a second photonic crystal containing an object to be cloaked and a first photonic crystal doped with a gain dopant, which are sequentially arranged. The first photonic crystal exhibits Dirac-like cone dispersion, the second photonic crystal has a photonic band gap, and a Dirac-like point frequency of the first photonic crystal is the same as a band-edge frequency of the photonic band gap of the second photonic crystal. The lossy dopant and the gain dopant are such that relative permittivities of the lossy dopant and the gain dopant are complex conjugates, and relative permeabilities of the lossy dopant and the gain dopant are 1. The stealth effect of the device is unidirectional, and the frequency of the cloaking electromagnetic wave is tunable.

This application is a Continuation Application of PCT/CN2024/089779, filed on Apr. 25, 2024, which is incorporated by reference for all purposes as if fully set forth herein.

### FIELD OF THE INVENTION

The present invention relates to the field of electromagnetic wave stealth technology, and provides a unidirectional electromagnetic wave stealth device and a method for manufacturing the same.

### DESCRIPTION OF THE RELATED ART

Electromagnetic wave stealth technology has consistently been a focal point of research in both military and civilian domains. The center objective of the technology is to minimize the detectability of concealed objects, thereby evading enemy detection equipment or enhancing the confidentiality of civilian equipment. With the continuous advancement of technology, electromagnetic wave stealth technology has evolved through multiple stages of development, yet still faces numerous challenges and limitations.

Traditional electromagnetic wave stealth methods mainly include absorption or directional scattering stealth that makes objects appear transparent to observers and mimicry camouflage. While these methods can achieve stealth effects to some extent, each has significant shortcomings. Absorption or directional scattering stealth reduces scattered energy received by detectors through electromagnetic wave absorption or modulation of an object's radar cross-section (RCS). This approach works when there is no background field in the space or when the background field is excluded from measurement targets. However, in complex backgrounds, the stealth effect may be severely degraded and could even precipitate exposure due to interference from background signals.

The stealth method of making objects appear transparent to observers operates by suppressing scattering from an object, allowing waves for detection to neither scatter nor be absorbed in any direction. While this physically perfect stealth concept is quite appealing, extremely stringent requirements are imposed on the electromagnetic parameters of materials. The practical implementation proves exceptionally challenging, making it difficult to achieve widespread real-world applications.

Mimicry camouflage achieves concealment by modulating scattered light from objects to match a background environment to blend into the background. However, the stealth effect of this method is heavily dependent on a specific background environment. Once the background environment changes, the stealth effect is significantly degraded, resulting in relatively limited applicability scenarios

In summary, although certain achievements have been made in the development of electromagnetic wave stealth technology, it still faces numerous challenges, particularly the limitations in achieving unidirectional electromagnetic wave stealth and tunability. Therefore, it is necessary to propose a novel electromagnetic wave stealth device.

### SUMMARY OF THE INVENTION

For this, embodiments of the present invention provide a unidirectional electromagnetic wave stealth device and a method for manufacturing same, to solve the problems of failing to achieve unidirectional electromagnetic wave stealth, that is, stealth for electromagnetic waves incident from a specific direction and lacking of tunability in the related art.

To resolve the foregoing problem, embodiments of the present invention provide a unidirectional electromagnetic wave stealth device. The device includes a first photonic crystal doped with a lossy dopant, a second photonic crystal containing an object to be cloaked, and a first photonic crystal doped with a gain dopant. The first photonic crystal doped with the lossy dopant, the second photonic crystal containing the object to be cloaked, and the first photonic crystal doped with the gain dopant are sequentially arranged.

The first photonic crystal doped with the lossy dopant includes the first photonic crystal and the lossy dopant, the second photonic crystal containing the object to be cloaked includes the second photonic crystal and the object to be cloaked, and the first photonic crystal doped with the gain dopant includes the first photonic crystal and the gain dopant.

The first photonic crystal exhibits Dirac-like cone dispersion, the second photonic crystal has a photonic band gap, and a Dirac-like point frequency of the first photonic crystal is the same as a band-edge frequency of the photonic band gap of the second photonic crystal.

The lossy dopant and the gain dopant meet the following conditions: relative permittivities of the lossy dopant and the gain dopant are complex conjugates, and relative permeabilities of the lossy dopant and the gain dopant are 1.

In an embodiment of the present invention, a two-dimensional planar structure of the unidirectional electromagnetic wave stealth device specifically includes:

the first photonic crystal doped with the lossy dopant and the first photonic crystal doped with the gain dopant are both composed of dielectric cylinders arranged in a square lattice, with the lossy dopant and the gain dopant in square shapes respectively doped in the middle; and

the second photonic crystal containing the object to be cloaked is composed of dielectric cylinders arranged in a square lattice, with the object to be cloaked in a square shape placed in the middle.

In an embodiment of the present invention, a value range of a relative permittivity ε₁ of the dielectric cylinders in the first photonic crystal is 3 to 50, a relative permeability of the dielectric cylinders is 1, a value range of a lattice constant α₁ of the dielectric cylinders is 0.01 mm to 1 m, and a value range of a radius r₁ of the dielectric cylinders is 0.05α₁ to 0.5α₁.

In an embodiment of the present invention, side lengths of the lossy dopant and the gain dopant in the square shapes are both 2α₁, relative permeabilities of the lossy dopant and the gain dopant are 1, the relative permittivities of the lossy dopant and the gain dopant are respectively ε_{d,L} and ε_{d,R}, value ranges of ε_{d,L} and ε_{d,R} are that real parts and imaginary parts all range from 3 to 50, ε_{d,L} and ε_{d,R} are complex conjugates of each other, that is, ε_{d,R}=ε*_{d,L}, α₁ denotes a lattice constant, and a value range of the lattice constant is 0.01 mm to 1 m.

In an embodiment of the present invention, a value range of a relative permittivity ε₂ of the dielectric cylinders in the second photonic crystal is 3 to 50, a relative permeability of the dielectric cylinders is 1, a value range of a lattice constant α₂ of the dielectric cylinders is 0.01 mm to 1 m, and a value range of a radius r₁ of the dielectric cylinders is 0.05α₂ to 0.5α₂.

In an embodiment of the present invention, a three-dimensional structure of the unidirectional electromagnetic wave stealth device specifically includes:

the first photonic crystal doped with the lossy dopant and the first photonic crystal doped with the gain dopant are both composed of dielectric-metal composite spheres arranged in a cubic lattice, with dielectric columns of the lossy dopant and dielectric columns of the gain dopant with square-shaped cross-sections respectively doped in the middle; and

the second photonic crystal containing the object to be cloaked is composed of dielectric-metal composite spheres arranged in a cubic lattice, with the object to be cloaked placed in the middle of the second photonic crystal.

In an embodiment of the present invention, each of the dielectric-metal composite spheres in the first photonic crystal includes a center being non-magnetic metal with a radius of r₁ₘ and an outer layer being a dielectric shell layer with a relative permittivity of ε_{1d}, a relative permeability of 1, and a radius of r_{1d}, a value range of the radius r₁ₘ is 0.01α₁ to 0.4α₁, a value range of the relative permittivity ε_{1d} is 3 to 50, a value range of the radius r_{1d} is r₁ₘ to 0.5α₁, α₁ denotes a lattice constant, and a value range of the lattice constant is 0.01 mm to 1 m.

In an embodiment of the present invention, side lengths of the cross-sections of the dielectric columns of the lossy dopant and the dielectric columns of the gain dopant with the square-shaped cross-sections are both α₁, relative permeabilities of the dielectric columns of the lossy dopant and the dielectric columns of the gain dopant are 1, relative permittivities of the dielectric columns of the lossy dopant and the dielectric columns of the gain dopant are respectively ε_{d,L} and ε_{d,R}, value ranges of ε_{d,L} and ε_{d,R} are that real parts and imaginary parts all range from 3 to 50, ε_{d,L} and ε_{d,R} are complex conjugates of each other, that is, ε_{d,R}=ε*_{d,L}, α₁ denotes a lattice constant, and a value range of the lattice constant is 0.01 mm to 1 m.

In an embodiment of the present invention, each of the dielectric-metal composite spheres in the second photonic crystal includes a center being non-magnetic metal with a radius of r₂ₘ and an outer layer being a dielectric shell layer with a relative permittivity of ε_{2d}, a relative permeability of 1, and a radius of r_{2d}, a value range of the radius r₂ₘ is 0.01α₂ to 0.4α₂, a value range of the relative permittivity ε_{2d} is 3 to 50, a value range of the radius r_{2d} is r₂ₘ to 0.5α₂, α₂ denotes a lattice constant, and a value range of the lattice constant is 0.01 mm to 1 m.

Embodiments of the present invention further provide a method for manufacturing a unidirectional electromagnetic wave stealth device. The method is used for manufacturing the foregoing unidirectional electromagnetic wave stealth device, and specifically includes:

constructing a first photonic crystal and a second photonic crystal such that the first photonic crystal exhibits Dirac-like cone dispersion, the second photonic crystal has a photonic band gap, and a Dirac-like point frequency of the first photonic crystal is the same as a band-edge frequency of the photonic band gap of the second photonic crystal;

constructing a lossy dopant and a gain dopant such that relative permittivities of the lossy dopant and the gain dopant are complex conjugates, and relative permeabilities of the lossy dopant and the gain dopant are 1;

doping the lossy dopant and the gain dopant into the first photonic crystal respectively to obtain a first photonic crystal doped with the lossy dopant and a first photonic crystal doped with the gain dopant, and placing an object to be cloaked in the second photonic crystal to obtain a second photonic crystal containing the object to be cloaked; and

sequentially arranging the first photonic crystal doped with the lossy dopant, the second photonic crystal containing the object to be cloaked, and the first photonic crystal doped with the gain dopant to complete manufacturing of the unidirectional electromagnetic wave stealth device.

As can be seen from the foregoing technical solutions, the present invention has the following beneficial effects:

The embodiments of the present invention provide a unidirectional electromagnetic wave stealth device and a method for manufacturing the same. The device of the present invention can achieve electromagnetic wave stealth for an object placed at the center of the second photonic crystal. The stealth effect is not related to the material of the object to be cloaked. The device of the present invention has a unidirectional stealth effect, i.e., only has a stealth characteristic for electromagnetic waves incident from the side of the first photonic crystal doped with the lossy dopant. In this case, the reflectance of electromagnetic waves is approximately 0, the transmittance of electromagnetic waves approaches 1, and emergent waves maintain a planar wavefront. The frequency of the cloaking electromagnetic wave of the device of the present invention is tunable, and the frequency of the cloaking electromagnetic wave can be changed by changing the structural dimensions of the photonic crystal. The frequency of the cloaking electromagnetic wave can in principle be located in microwave, terahertz, infrared, visible light, among other bands.

### BRIEF DESCRIPTION OF THE DRAWINGS

To describe the technical solutions in the embodiments of the present invention or in the prior art more clearly, the accompanying drawings that need to be used in the embodiments are briefly described below. The features and advantages of the present invention will be more clearly understood by referring to the accompanying drawings, which are schematic and should not be construed as limiting the present invention in any way. A person of ordinary skill in the art can obtain other accompanying drawings without creative efforts based on these accompanying drawings. Where:

FIG. 1 is a schematic structural diagram of a unidirectional electromagnetic wave stealth device according to an embodiment;

FIG. 2 is a schematic diagram of a two-dimensional stealth device according to an embodiment;

FIG. 3 is a band diagram of first and second photonic crystals in a two-dimensional stealth device according to an embodiment;

FIG. 4 shows numerical simulation results of a two-dimensional stealth device according to an embodiment;

FIG. 5 is a schematic diagram of a three-dimensional stealth device according to an embodiment;

FIG. 6 is a band diagram of first and second photonic crystals in a three-dimensional stealth device according to an embodiment;

FIG. 7 shows numerical simulation results of a three-dimensional stealth device according to an embodiment; and

FIG. 8 is a flowchart of a method for manufacturing a unidirectional electromagnetic wave stealth device according to an embodiment.

Reference numerals: 1. a first photonic crystal; 2. a second photonic crystal; 3. lossy dopant; 4. gain dopant; and 5. an object to be cloaked.

### DETAILED DESCRIPTION OF THE PREFERRED EMBODIMENTS

In order to make the objectives, technical solutions and advantages of the embodiments of the present invention clearer, the technical solutions in the embodiments of the present invention will be clearly and completely described below in conjunction with the accompanying drawings in the embodiments of the present invention. Obviously, the described embodiments are some of the embodiments of the present invention, rather than all of the embodiments. All other embodiments obtained by persons of ordinary skill in the art based on the embodiments of the present invention without creative efforts fall within the protection scope of the present invention.

### Embodiment 1

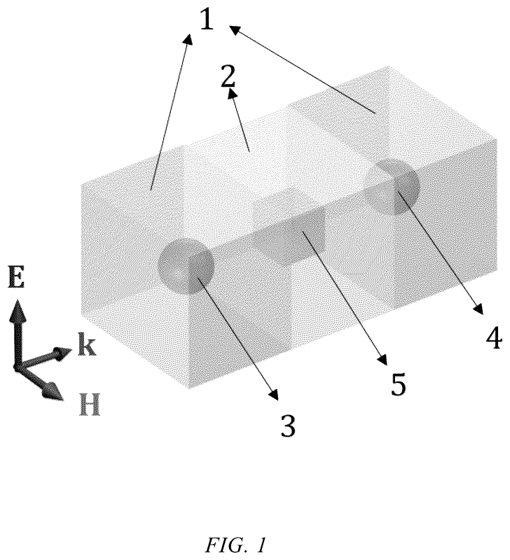

To solve the problems of failing to achieve unidirectional electromagnetic wave stealth, that is, stealth for electromagnetic waves incident from a specific direction and lacking of tunability in the related art, as shown in FIG. 1, embodiments of the present invention provide a unidirectional electromagnetic wave stealth device. The device includes a first photonic crystal doped with a lossy dopant, a second photonic crystal containing an object to be cloaked, and a first photonic crystal doped with a gain dopant. The first photonic crystal doped with the lossy dopant, the second photonic crystal containing the object to be cloaked, and the first photonic crystal doped with the gain dopant are sequentially arranged.

The first photonic crystal doped with the lossy dopant includes the first photonic crystal 1 and the lossy dopant 3, the second photonic crystal containing the object to be cloaked includes the second photonic crystal 2 and the object to be cloaked 5, and the first photonic crystal doped with the gain dopant includes the first photonic crystal 1 and the gain dopant 4. The lossy dopant 3 and the gain dopant 4 exhibit diverse morphologies in three-dimensional structures, and may present as spheres or may present as cuboids. It needs to be emphasized that FIG. 1 only serves as a schematic diagram, and other possible morphologies may exist in practice. The first photonic crystal 1 exhibits Dirac-like cone dispersion, the second photonic crystal 2 has a photonic band gap, and a Dirac-like point frequency of the first photonic crystal 1 is the same as a band-edge frequency of the photonic band gap of the second photonic crystal 2.

The lossy dopant 3 and the gain dopant 4 meet the following conditions: relative permittivities of the lossy dopant 3 and the gain dopant 4 are complex conjugates, and relative permeabilities of the lossy dopant 3 and the gain dopant 4 are 1.

As can be learned from the foregoing technical solutions, the present invention provides a unidirectional electromagnetic wave stealth device, including a first photonic crystal doped with a lossy dopant, a second photonic crystal containing an object to be cloaked, and a first photonic crystal doped with a gain dopant. The first photonic crystal exhibits Dirac-like cone dispersion, the second photonic crystal has a photonic band gap, and a Dirac-like point frequency of the first photonic crystal is the same as a band-edge frequency of the photonic band gap of the second photonic crystal. The lossy dopant and the gain dopant meet the following conditions: relative permittivities of the lossy dopant and the gain dopant are complex conjugates, and relative permeabilities of the lossy dopant and the gain dopant are 1. The device of the present invention can achieve electromagnetic wave stealth for an object placed at the center of the second photonic crystal. The stealth effect is not related to the material of the object to be cloaked. The device of the present invention has a unidirectional stealth effect, i.e., only has a stealth characteristic for electromagnetic waves incident from the side of the first photonic crystal doped with the lossy dopant. In this case, the reflectance of electromagnetic waves is approximately 0, and the transmittance approaches 1, and the emergent waves maintain a planar wavefront. The frequency of the cloaking electromagnetic wave of the device of the present invention is tunable, and the frequency of the cloaking electromagnetic wave can be changed by changing the structural dimensions of the photonic crystal. The frequency of the cloaking electromagnetic wave can in principle be located in microwave, terahertz, infrared, visible light, among other bands.

In this embodiment, a unidirectional electromagnetic wave stealth device formed by a first photonic crystal doped with a lossy dopant on the left side, a second photonic crystal containing an object to be cloaked in the middle, and a first photonic crystal doped with a gain dopant on the right side is designed in the present invention, as shown in FIG. 1. Specifically, the first photonic crystal 1 exhibits Dirac-like cone dispersion, the second photonic crystal 2 has a photonic band gap, and they need to meet that a Dirac-like point frequency of the first photonic crystal 1 is the same as a band-edge frequency of the photonic band gap of the second photonic crystal 2. The lossy dopant 3 doped in the first photonic crystal doped with the lossy dopant on the left side and the gain dopant 4 doped in the first photonic crystal doped with the gain dopant on the right side need to meet the following conditions: relative permittivities of the lossy dopant 3 and the gain dopant 4 are complex conjugates, and relative permeabilities of the lossy dopant 3 and the gain dopant 4 are 1.

Further, at the center of the second photonic crystal containing the object to be cloaked, the object to be cloaked 5 is placed. Without the stealth device, the object at the center generates intense scattering for incident electromagnetic waves, and therefore is easily detectable. With proper parameters, the device can achieve unidirectional stealth for electromagnetic waves. That is, electromagnetic waves incident from the left side can pass through the entire device without reflection and maintain a complete planar wavefront without being affected by the object at the center.

The mechanism of the stealth device of the present invention lies in that the first photonic crystal doped with the lossy dopant can absorb most of incident electromagnetic waves, the remaining small part of electromagnetic energy is transferred to the first photonic crystal doped with the gain dopant on the right side through the second photonic crystal containing the object to be cloaked in the middle, and the electromagnetic energy is amplified using the gain dopant 4 doped in the first photonic crystal doped with the gain dopant on the right side, so that the incident electromagnetic waves can be restored on the right side. In this process, because the electromagnetic energy in the second photonic crystal containing the object to be cloaked is very low, the object to be cloaked 5 placed in the middle does not significantly affect the overall transmission of electromagnetic waves, and electromagnetic waves exhibit a diffractive characteristic in the second photonic crystal 2 with the band-edge frequency and can propagate around the object to be cloaked, thereby eventually achieving electromagnetic wave stealth.

It is to be noted that the foregoing mechanism only applies to a case that electromagnetic waves are incident from the side of the first photonic crystal 1 doped with the lossy dopant. If electromagnetic waves are incident from the side of the first photonic crystal doped with the gain dopant, electromagnetic wave stealth is not achieved. Therefore, the electromagnetic wave stealth device is only effective for unidirectional incident electromagnetic waves, i.e., is a unidirectional electromagnetic wave stealth device.

The stealth device may have a two-dimensional planar structure or may have a three-dimensional structure. For example, specific implementation solutions are as follows:

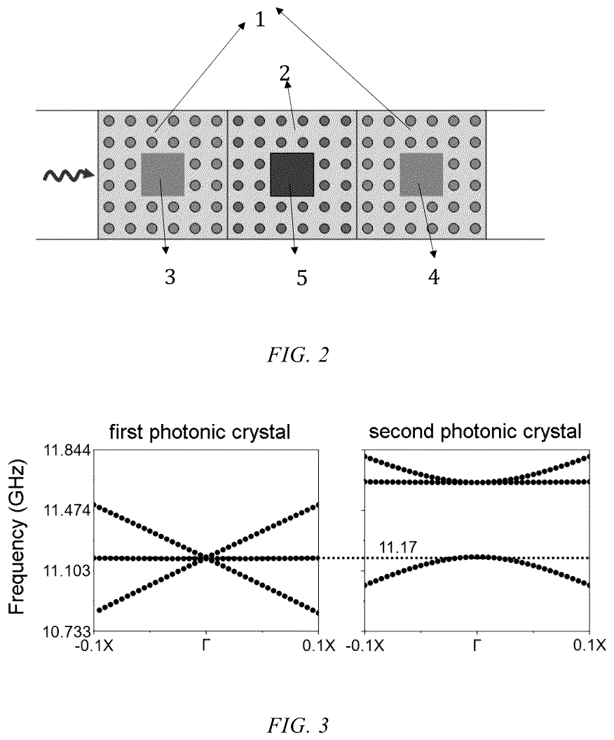

FIG. 2 is a schematic diagram of a two-dimensional stealth device. The first photonic crystal doped with the lossy dopant (on the left side, and including the first photonic crystal 1 and the lossy dopant 3) and the first photonic crystal doped with the gain dopant (on the right side, and including the first photonic crystal 1 and the gain dopant 4) are both composed of dielectric cylinders arranged in a square lattice, with the lossy dopant 3 and the gain dopant 4 in square shapes respectively doped in the middle. A value range of a relative permittivity ε₁ of the dielectric cylinders in the first photonic crystal 1 is 3 to 50, a relative permeability of the dielectric cylinders is 1, a value range of a lattice constant α₁ of the dielectric cylinders is 0.01 mm to 1 m, and a value range of a radius r₁ of the dielectric cylinders is 0.05α₁ to 0.5α₁. Side lengths of the lossy dopant 3 and the gain dopant 4 in the square shapes are both 2α₁, relative permeabilities of the lossy dopant 3 and the gain dopant 4 are 1, the relative permittivities of the lossy dopant 3 and the gain dopant 4 are respectively ε_{d,L} and ε_{d,R}, value ranges of ε_{d,L} and ε_{d,R} are such that real parts and imaginary parts all range from 3 to 50, ε_{d,L} and ε_{d,R} are complex conjugates of each other, that is, ε_{d,R}=ε*_{d,L} (real parts are the same, and imaginary parts are opposites of each other).

The second photonic crystal containing the object to be cloaked (including the second photonic crystal 2 and the object to be cloaked 5) in the middle is composed of dielectric cylinders arranged in a square lattice, with the object to be cloaked 5 in a square shape placed in the middle. A value range of a relative permittivity ε₂ of the dielectric cylinders is 3 to 50, a relative permeability of the dielectric cylinders is 1, a value range of a lattice constant α₂ of the dielectric cylinders is 0.01 mm to 1 m, and a value range of a radius r₁ of the dielectric cylinders is 0.05α₂ to 0.5α₂.

To achieve electromagnetic wave stealth, the first photonic crystal 1 exhibits Dirac-like cone dispersion, and the second photonic crystal 2 has a photonic band gap, and they need to meet that a Dirac-like point frequency of the first photonic crystal 1 is the same as a band-edge frequency of the photonic band gap of the second photonic crystal 2. The condition can be met by adjusting the geometric and electromagnetic parameters of the two types of photonic crystals. α₁=α₂=16.2 mm, r₁=3.75 mm, r₂=3.55 mm, and ε₁=ε₂=7.5 are selected.

FIG. 3 is a band diagram of the first photonic crystal 1 and the second photonic crystal 2. It can be seen that the first photonic crystal 1 exhibits Dirac-like cone dispersion, the second photonic crystal 2 has a clear photonic band gap, and a Dirac-like point frequency of the first photonic crystal 1 is the same as a band-edge frequency of a lower band of the second photonic crystal 2, both being 11.17 GHz.

To achieve electromagnetic wave stealth, it further needs to be met that relative permittivities ε_{d,L} and ε_{d,R} of the dopants doped in the first photonic crystal doped with the lossy dopant and the first photonic crystal doped with the gain dopant are complex conjugates of each other. Through parameter optimization, ε_{d,L}=1.84+0.26i and ε_{d,R}=1.84−0.26i are selected.

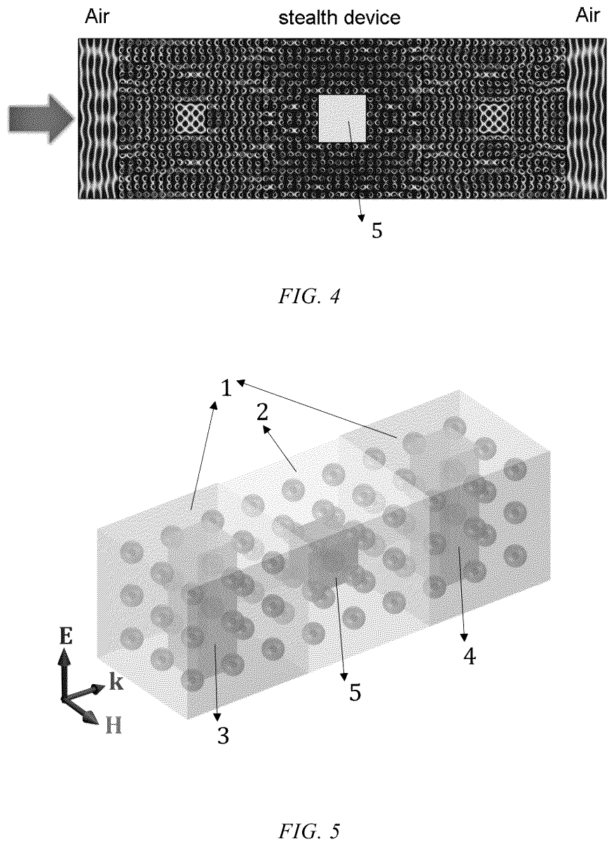

FIG. 4 gives simulation results using numerical software. When plane electromagnetic waves with a frequency of 11.17 GHz are incident from an air end on the left side, the object to be cloaked 5 in a square shape is provided at the center of the stealth device. The simulation results show that the reflectance of the electromagnetic waves is approximately 0, the transmittance of the electromagnetic waves approaches 1, and emergent electromagnetic waves maintain a planar wavefront, indicating that the device has an excellent electromagnetic wave stealth characteristic.

The stealth principle may also be extended to three-dimensional models. FIG. 5 is a schematic diagram of a three-dimensional stealth device. The first photonic crystal doped with the lossy dopant (on the left side, and including the first photonic crystal I and the lossy dopant 3) and the first photonic crystal doped with the gain dopant (on the right side, and including the first photonic crystal 1 and the gain dopant 4) are both composed of dielectric-metal composite spheres arranged in a cubic lattice, with dielectric columns of the lossy dopant and dielectric columns of the gain dopant with square-shaped cross-sections respectively doped in the middle. Each of the dielectric-metal composite spheres in the first photonic crystal 1 includes a center being non-magnetic metal (for example, copper, or aluminum) with a radius of r₁ₘ and an outer layer being a dielectric shell layer with a relative permittivity of ε_{1d}, a relative permeability of 1, and a radius of r_{1d}, a value range of the radius r₁ₘ is 0.01α₁ to 0.4α₁, a value range of the relative permittivity ε_{1d} is 3 to 50, a value range of the radius r_{1d} is r₁ₘ to 0.5α₁, α₁ denotes a lattice constant, and a value range of the lattice constant is 0.01 mm to 1 m. Side lengths of the cross-sections of the dielectric columns of the lossy dopant and the dielectric columns of the gain dopant with the square-shaped cross-sections are both α₁, relative permeabilities of the dielectric columns of the lossy dopant and the dielectric columns of the gain dopant are 1, relative permittivities of the dielectric columns of the lossy dopant and the dielectric columns of the gain dopant are respectively ε_{d,L} and ε_{d,R}, value ranges of ε_{d,L} and ε_{d,R} are such that real parts and imaginary parts all range from 3 to 50, ε_{d,L} and ε_{d,R} are complex conjugates of each other, that is, ε_{d,R}=ε*_{d,L} (real parts are the same, and imaginary parts are opposites of each other).

The second photonic crystal containing the object to be cloaked (including the second photonic crystal 2 and the object to be cloaked 5) in the middle is composed of dielectric-metal composite spheres arranged in a cubic lattice, with the object to be cloaked 5 placed in the middle. Each of the dielectric-metal composite spheres in the second photonic crystal 2 includes a center being non-magnetic metal (for example, copper, or aluminum) with a radius of r₂ₘ and an outer layer being a dielectric shell layer with a relative permittivity of ε_{2d}, a relative permeability of 1, and a radius of r_{2d}, a value range of the radius r₂ₘ is 0.01α₂ to 0.4α₂, a value range of the relative permittivity ε_{2d} is 3 to 50, a value range of the radius r_{2d} is r₂ₘ to 0.5α₂, α₂ denotes a lattice constant, and a value range of the lattice constant is 0.01 mm to 1 m.

Same as the two-dimensional model, to achieve electromagnetic wave stealth, the first photonic crystal 1 exhibits Dirac-like cone dispersion, and the second photonic crystal 2 has a band gap, and they need to meet that a Dirac-like point frequency of the first photonic crystal 1 is the same as a band-edge frequency of the band gap of the second photonic crystal 2. The condition can be met by adjusting the geometric and electromagnetic parameters of the two types of photonic crystals. α₁=α₂=12.8 mm, r₁ₘ=1.61 mm, r_{1d}=5.12 mm, r₂ₘ=1.92 mm, r_{2d}=4.65 mm, ε₁=30, and ε_{2d}=35.03 are selected.

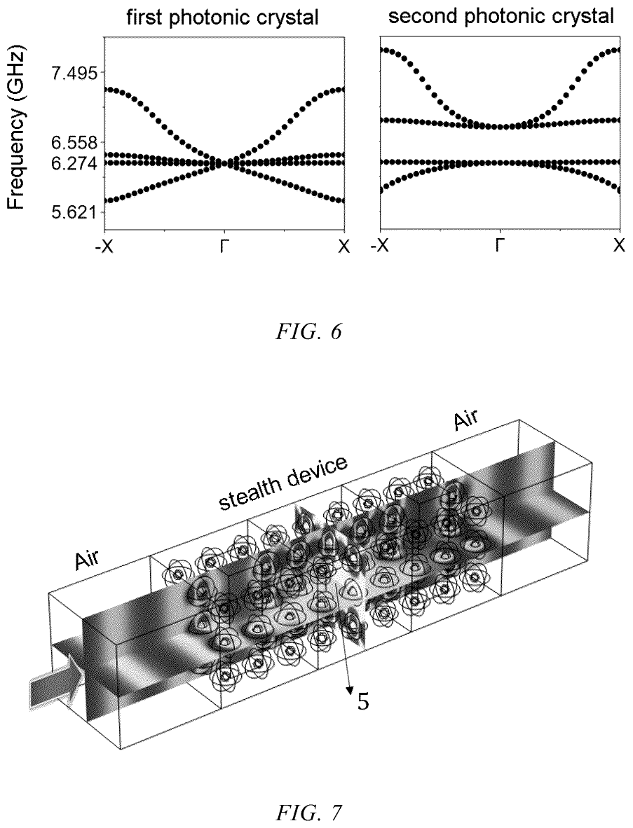

FIG. 6 is a band diagram of a three-dimensional first photonic crystal 1 and second photonic crystal 2. It can be seen that the first photonic crystal 1 has a clear photonic band gap, the second photonic crystal 2 exhibits Dirac-like cone dispersion, and band-edge frequencies of lower two bands of the first photonic crystal 1 is the same as a Dirac-like point frequency of the second photonic crystal 2, both being 6.274 GHz.

To achieve electromagnetic wave stealth, it further needs to be met that relative permittivities ε_{d,L} and ε_{d,R} of the dopants doped in the first photonic crystal doped with the lossy dopant and the first photonic crystal doped with the gain dopant are complex conjugates of each other. Through parameter optimization, ε_{d,L}=0.5+2.1i and ε_{d,R}=0.5−2.1i are selected.

FIG. 7 gives simulation results using numerical software. When plane electromagnetic waves with a frequency of 6.274 GHz are incident from an air end on the left side, the object to be cloaked 5 in a cubic shape is provided at the center of the stealth device. The simulation results show that the reflectance of the electromagnetic waves is approximately 0, the transmittance of the electromagnetic waves approaches 1, and emergent electromagnetic waves maintain a planar wavefront, indicating that the device has an excellent electromagnetic wave stealth characteristic.

### Embodiment 2

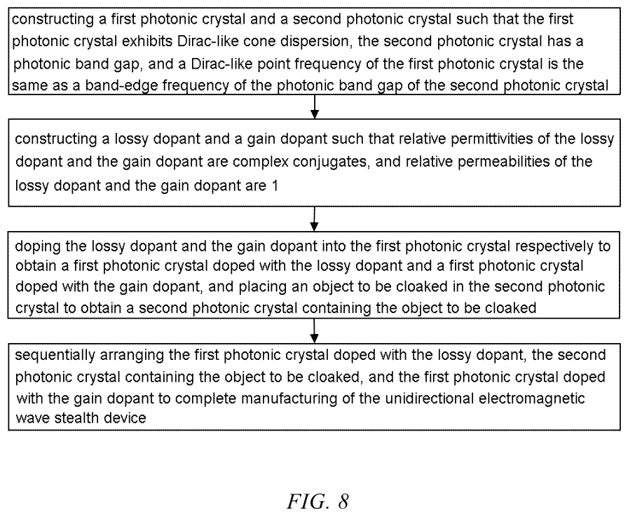

As shown in FIG. 8, the present invention provides a method for manufacturing a unidirectional electromagnetic wave stealth device. The method is used for manufacturing the foregoing unidirectional electromagnetic wave stealth device of Embodiment 1, and specifically includes:

constructing a first photonic crystal and a second photonic crystal such that the first photonic crystal exhibits Dirac-like cone dispersion, the second photonic crystal has a photonic band gap, and a Dirac-like point frequency of the first photonic crystal is the same as a band-edge frequency of the photonic band gap of the second photonic crystal;

constructing a lossy dopant and a gain dopant such that relative permittivities of the lossy dopant and the gain dopant are complex conjugates, and relative permeabilities of the lossy dopant and the gain dopant are 1;

doping the lossy dopant and the gain dopant into the first photonic crystal respectively to obtain a first photonic crystal doped with the lossy dopant and a first photonic crystal doped with the gain dopant, and placing an object to be cloaked in the second photonic crystal to obtain a second photonic crystal containing the object to be cloaked; and

sequentially arranging the first photonic crystal doped with the lossy dopant, the second photonic crystal containing the object to be cloaked, and the first photonic crystal doped with the gain dopant to complete manufacturing of the unidirectional electromagnetic wave stealth device.

The method for manufacturing a unidirectional electromagnetic wave stealth device of this embodiment is used for manufacturing the foregoing unidirectional electromagnetic wave stealth device. Therefore, for the specific implementation in the method for manufacturing a unidirectional electromagnetic wave stealth device, refer to the foregoing embodiment part of the unidirectional electromagnetic wave stealth device. To avoid redundancy, details are not described again herein.

It should be noted that, the above description only provides preferred embodiments of the present invention and the employed technical principles. It should be appreciated by those skilled in the art that the present invention is not limited to the particular embodiments described herein. Those skilled in the art may make various obvious changes, readjustments, and replacements without departing from the scope of protection of the present invention. Therefore, while the present invention is illustrated in detail in combination with the above embodiments, the present invention is not only limited to the above embodiments, and can further include more other equivalent embodiments without departing from the concept of the present invention. The scope of the present invention is defined by the scope of the appended claims.

What is claimed is:

1. A unidirectional electromagnetic wave stealth device, comprising a first photonic crystal doped with a lossy dopant, a second photonic crystal containing an object to be cloaked, and a first photonic crystal doped with a gain dopant, wherein the first photonic crystal doped with the lossy dopant, the second photonic crystal containing the object to be cloaked, and the first photonic crystal doped with the gain dopant are sequentially arranged;
the first photonic crystal doped with the lossy dopant comprises the first photonic crystal and the lossy dopant, the second photonic crystal containing the object to be cloaked comprises the second photonic crystal and the object to be cloaked, and the first photonic crystal doped with the gain dopant comprises the first photonic crystal and the gain dopant;
the first photonic crystal exhibits Dirac-like cone dispersion, the second photonic crystal has a photonic band gap, and a Dirac-like point frequency of the first photonic crystal is the same as a band-edge frequency of the photonic band gap of the second photonic crystal; and
the lossy dopant and the gain dopant are such that relative permittivities of the lossy dopant and the gain dopant are complex conjugates, and relative permeabilities of the lossy dopant and the gain dopant are 1.

2. The unidirectional electromagnetic wave stealth device according to claim 1, wherein a two-dimensional planar structure of the unidirectional electromagnetic wave stealth device specifically comprises:
the first photonic crystal doped with the lossy dopant and the first photonic crystal doped with the gain dopant are both composed of dielectric cylinders arranged in a square lattice with the lossy dopant and the gain dopant in square shapes respectively doped in the middle; and
the second photonic crystal containing the object to be cloaked is composed of dielectric cylinders arranged in a square lattice, with the object to be cloaked in a square shape placed in the middle.

3. The unidirectional electromagnetic wave stealth device according to claim 2, wherein a value range of a relative permittivity ε₁ of the dielectric cylinders in the first photonic crystal is 3 to 50, a relative permeability of the dielectric cylinders is 1, a value range of a lattice constant α₁ of the dielectric cylinders is 0.01 mm to 1 m, and a value range of a radius r₁ of the dielectric cylinders is 0.05α₁ to 0.5α₁.

4. The unidirectional electromagnetic wave stealth device according to claim 2, wherein side lengths of the lossy dopant and the gain dopant in the square shapes are both 2α₁, relative permeabilities of the lossy dopant and the gain dopant are 1, the relative permittivities of the lossy dopant and the gain dopant are respectively ε_{d,L} and ε_{d,R}, value ranges of ε_{d,L} and ε_{d,R} are such that real parts and imaginary parts all range from 3 to 50, ε_{d,L} and ε_{d,R} are complex conjugates of each other, that is, ε_{d,R}=ε*_{d,L}, α₁ denotes a lattice constant, and a value range of the lattice constant is 0.01 mm to 1 m.

5. The unidirectional electromagnetic wave stealth device according to claim 2, wherein a value range of a relative permittivity ε₂ of the dielectric cylinders in the second photonic crystal is 3 to 50, a relative permeability of the dielectric cylinders is 1, a value range of a lattice constant α₂ of the dielectric cylinders is 0.01 mm to 1 m, and a value range of a radius r₁ of the dielectric cylinders is 0.05α₂ to 0.5α₂.

6. The unidirectional electromagnetic wave stealth device according to claim 1, wherein a three-dimensional structure of the unidirectional electromagnetic wave stealth device specifically comprises:
the first photonic crystal doped with the lossy dopant and the first photonic crystal doped with the gain dopant are both composed of dielectric-metal composite spheres arranged in a cubic lattice with dielectric columns of the lossy dopant and dielectric columns of the gain dopant with square-shaped cross-sections respectively doped in the middle; and
the second photonic crystal containing the object to be cloaked is composed of dielectric-metal composite spheres arranged in a cubic lattice, with the object to be cloaked placed in the middle.

7. The unidirectional electromagnetic wave stealth device according to claim 6, wherein each of the dielectric-metal composite spheres in the first photonic crystal comprises a center being non-magnetic metal with a radius of r₁ₘ and an outer layer being a dielectric shell layer with a relative permittivity of ε_{1d}, a relative permeability of 1, and a radius of r_{1d}, a value range of the radius r₁ₘ is 0.01α₁ to 0.4α₁, a value range of the relative permittivity ε_{1d} is 3 to 50, a value range of the radius r_{1d} is r₁ₘ to 0.5α₁, α₁ denotes a lattice constant, and a value range of the lattice constant is 0.01 mm to 1 m.

8. The unidirectional electromagnetic wave stealth device according to claim 6, wherein side lengths of the cross-sections of the dielectric columns of the lossy dopant and the dielectric columns of the gain dopant with the square-shaped cross-sections are both α₁, relative permeabilities of the dielectric columns of the lossy dopant and the dielectric columns of the gain dopant are 1, relative permittivities of the dielectric columns of the lossy dopant and the dielectric columns of the gain dopant are respectively ε_{d,L} and ε_{d,R}, value ranges of ε_{d,L} and ε_{d,R} are such that real parts and imaginary parts all range from 3 to 50, ε_{d,L} and ε_{d,R} are complex conjugates of each other, that is, ε_{d,R}=ε*_{dL}, α₁ denotes a lattice constant, and a value range of the lattice constant is 0.01 mm to 1 m.

9. The unidirectional electromagnetic wave stealth device according to claim 6, wherein each of the dielectric-metal composite spheres in the second photonic crystal comprises a center being non-magnetic metal with a radius of r₂ₘ and an outer layer being a dielectric shell layer with a relative permittivity of ε_{2d}, a relative permeability of 1, and a radius of r_{2d}, a value range of the radius r₂ₘ is 0.01α₂ to 0.4α₂, a value range of the relative permittivity ε_{2d} is 3 to 50, a value range of the radius r_{2d} is r₂ₘ to 0.5α₂, α₂ denotes a lattice constant, and a value range of the lattice constant is 0.01 mm to 1 m.

10. A method for manufacturing a unidirectional electromagnetic wave stealth device, wherein the method is used for manufacturing the unidirectional electromagnetic wave stealth device according to claim 1, and specifically comprises:
constructing a first photonic crystal and a second photonic crystal such that the first photonic crystal exhibits Dirac-like cone dispersion, the second photonic crystal has a photonic band gap, and a Dirac-like point frequency of the first photonic crystal is the same as a band-edge frequency of the photonic band gap of the second photonic crystal;
constructing a lossy dopant and a gain dopant such that relative permittivities of the lossy dopant and the gain dopant are complex conjugates, and relative permeabilities of the lossy dopant and the gain dopant are 1;
doping the lossy dopant and the gain dopant into the first photonic crystal respectively to obtain a first photonic crystal doped with the lossy dopant and a first photonic crystal doped with the gain dopant, and placing an object to be cloaked in the second photonic crystal to obtain a second photonic crystal containing the object to be cloaked; and
sequentially arranging the first photonic crystal doped with the lossy dopant, the second photonic crystal containing the object to be cloaked, and the first photonic crystal doped with the gain dopant to obtain the unidirectional electromagnetic wave stealth device.
